(19) United States
(12) Patent Application Publication
(10) Pub. No.: US 2016/0001977 A1
(43) Pub. Date: Jan. 7, 2016

(54) TOILET REMOVAL AND DISPOSAL TRAY

(71) Applicants: Thomas A. Arthurs, Naples, FL (US); Jody A. Arthurs, Naples, FL (US)

(72) Inventors: Thomas A. Arthurs, Naples, FL (US); Jody A. Arthurs, Naples, FL (US)

(21) Appl. No.: 14/691,935

(22) Filed: Apr. 21, 2015

Related U.S. Application Data
(63) Continuation-in-part of application No. 14/323,383, filed on Jul. 3, 2014, now Pat. No. 9,091,048.

(51) Int. Cl. B65G 7/12; E03D 11/13

(52) U.S. Cl. CPC B65G 7/12; E03D 11/135

(57) ABSTRACT

A toilet removal and disposal tray (1) for removing and transporting an old toilet (2) from a bathroom. The toilet removal and disposal tray has a planar base panel (3) having a perimeter edge (6) and a perimeter wall (7) extending upward a predetermined distance from the perimeter edge. The perimeter wall contains any liquids that leak from the toilet after the toilet has been uninstalled and placed on the toilet removal and disposal tray. A drain line connector (12), one or more bolt hole connectors (13) and/or one or more straps (19) attach the toilet to the toilet removal and disposal tray. A drain line cap (23) may also be provided to cover a sewer drain line after a toilet is removed from a bathroom.

### CROSS-REFERENCE TO RELATED APPLICATIONS

This application is a continuation-in-part application of U.S. patent application Ser. No. 14/323,383 filed on Jul. 3, 2014 which is currently pending. The patent application identified above is incorporated herein by reference in its entirety to provide continuity of disclosure.

### FIELD OF THE INVENTION

This invention relates to the removal of toilets from homes and other buildings, more particularly, to a tray used for removing a toilet from a bathroom and disposing of the toilet in a clean and sanitary manner.

### BACKGROUND OF THE INVENTION

Toilets are commonly removed by a worker standing over a toilet and pulling the toilet up from the floor and then setting the toilet directly on the floor of the bathroom. The toilet is then carried to a truck or trash bin for disposal.

The removal of toilets can be unsanitary and cause a mess in the bathroom and throughout a home while the toilet is being carried outside. This can occur from water that has not completely drained from the toilet leaking onto the bathroom floor and other parts of a home including carpeted areas while being carried outside. This can also occur from the wax ring on the bottom of the toilet being set directly on the bathroom floor.

In addition, this is a dangerous task because toilets may be heavy and awkward to handle. The worker can easily suffer personal injuries, such as back injuries, from carrying such a heavy object in such an awkward position or damage items in the home, such as walls and/or furniture.

Therefore, a need exists for a toilet removal and disposal tray that attaches to the bottom of a toilet and protects the floor from water leaking from the toilet and from coming into contact with the used wax ring located on the bottom of the old toilet. In addition, a need exists for a toilet removal and disposal tray that allows a user to easily transport a toilet by sliding the tray, rolling the tray and/or carrying the tray using elongated handles.

The relevant prior art includes the following references:

| Pat. No. | | Issue/ |
|---|---|---|
| (U.S. Pat. References) | Inventor | Publication Date |
| 3,391,905 | Burns | Jul. 9, 1968 |
| 5,074,572 | Delmerico et al. | Dec. 24, 1991 |
| 5,184,653 | Lacy | Feb. 9, 1993 |
| 5,373,593 | Decky et al. | Dec. 20, 1994 |
| 6,685,170 | Gwynn | Feb. 3, 2004 |
| 5,505,430 | Barnett | Apr. 9, 1996 |
| 5,556,076 | Jacquay | Sep. 17, 1996 |
| 6,135,466 | Irwin | Oct. 24, 2000 |
| 6,752,379 | Wall | Jun. 22, 2004 |
| 7,058,996 | Merrill | Jun. 13, 2006 |
| 7,107,632 | Huff et al. | Sep. 19, 2006 |
| 7,231,674 | Cernik | Jun. 19, 2007 |
| 2008/0109957 | Blancke | May 15, 2008 |
| 7,798,469 | Junka | Sep. 21, 2010 |
| 7,823,862 | Wakil | Nov. 2, 2010 |
| 8,313,130 | Hazel | Nov. 20, 2012 |
| 8,312,608 | Head | Nov. 20, 2012 |

### SUMMARY OF THE INVENTION

The primary object of the present invention is to provide a toilet removal and disposal tray that attaches to the bottom of a toilet and protects the floor from water leaking from the toilet and from coming into contact with the used wax ring.

An additional object of the present invention is to provide a toilet removal and disposal tray that allows a user to easily transport a toilet by sliding the tray, rolling the tray and/or carrying the tray using elongated handles.

An additional object of the present invention is to provide a toilet removal and disposal tray that is compact and easily carried and stored, such as in a plumber's work truck.

An additional object of the present invention is to provide a toilet removal and disposal tray that may be disposable so that it can be thrown with the toilet after use.

The present invention fulfills the above and other objects by providing a toilet removal and disposal tray for removing and transporting an old toilet from a bathroom. The toilet removal and disposal tray has a planar base panel having a perimeter edge and a perimeter wall extending upward a predetermined distance from the perimeter edge. The perimeter wall contains any liquids that leak from the toilet after the toilet has been uninstalled and placed on the toilet removal and disposal tray. The toilet removal and disposal tray may also be lined with an absorbent material to soak up any water that drains from the toilet into the toilet removal and disposal tray, thereby further preventing water from leaking onto the floor.

The toilet is secured to the toilet removal and disposal tray by a drain line connector, which is preferably a rounded cylindrical projection, which is centrally located on the toilet removal and disposal tray and fits into the drain line of the toilet. Two bolt hole connectors, which are preferably finger-shaped projections, are located on either side of the drain line holder and further secure the toilet to the toilet removal and disposal tray by fitting through bolt holes located on the base of the toilet. The bolt hole connectors and drain line connector constructed out of a resilient material that provides outward pressure against the drain line and the bolt holes when squeezed inward, thereby creating a pressure fit to prevent the toilet removal and disposal tray from separating from the toilet when the toilet is lifted off the ground. Alternatively, the bolt hole connectors and drain line connector may have finger springs that automatically expand outward to lock the bolt hole connectors and drain line connector to the toilet. Alternatively, the bolt hole connectors pressure may be locked onto the toilet using pressure fit washers or nuts.

Other features of the present invention may include a curved lip used for grasping the sides of the toilet removal and disposal tray, a strap for securing the toilet removal and disposal tray to the toilet, and a disposable liner.

The toilet and a toilet removal and disposal tray may be removed from the bathroom by sliding the a toilet removal and disposal tray across the floor or by carrying the a toilet removal and disposal tray using removable elongated handles that attach to the a toilet removal and disposal tray or by rolling the a toilet removal and disposal tray on wheels attached to the a toilet removal and disposal tray. The wheels may be attached directly to the toilet removal and disposal tray or to a dolly that is removably attachable to the a toilet removal and disposal tray.

The tray may be made of a reusable material or of a cheaper material so the tray can be discarded with the toilet after use.

The present invention may also include a drain line cap to be used after a toilet is removed from the sewer drain to prevent gas and odor from escaping from the sewer drain and into a bathroom. The drain line cap has a preferably circular-shaped upper panel and a perimeter wall that fits over a toilet drain flange. A gasket may be located along a lower edge of the perimeter wall and/or on an inner surface of the perimeter wall to create a seal between the drain line cap and the toilet drain flange. The drain line cap may be secured to the toilet drain flange using nuts and bolts similar to the method used to secure a toilet to the toilet drain flange. The drain line cap may also be secured using a friction fit created by the gasket and/or the perimeter wall and the toilet drain flange. The drain line cap may also have posts extending downward from a bottom surface of the panel that terminate with circular heads (similar to bolt heads) that will engage apertures and slots in the toilet drain flange, thereby allowing the drain line cap to be locked onto the toilet drain flange. An advantage of the drain line cap is that it may be removably attached to the toilet removal and disposal tray so that it will be readily available for use when an old toilet is removed.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a perspective side view of a toilet removal and disposal tray having a toilet located therein;

FIG. 2 is a top view of a toilet removal and disposal tray having a toilet located therein;

FIG. 3 is a perspective side view of a toilet removal and disposal tray having elongated handles attached thereto;

FIG. 4 is a cross sectional view along the line 2-2 of FIG. 2 is illustrated showing a toilet removal and disposal tray having a drain line connector and bolt hole connectors secured to the toilet by a pressure fit;

FIG. 5 is a cross sectional view along the line 2-2 of FIG. 2 showing a toilet removal and disposal tray having a drain line connector and bolt hole connectors secured to the toilet by finger springs;

FIG. 6 is a perspective bottom view of a toilet removal and disposal tray of the present invention having wheels located thereon;

FIG. 7 is a cross sectional view along the line 7-7 of FIG. 6;

FIG. 8 is a perspective side view of a simplified toilet removal and disposal tray of the present invention;

FIG. 9 is a perspective side view of a toilet removal and disposal tray having strap slots located thereon;

FIG. 10 is a perspective side view of a toilet removal and disposal tray having a toilet located therein secured by a strap;

FIG. 11 is a cross sectional view along the line 12-12 of FIG. 11;

FIG. 12 is an exploded perspective side view of a toilet removal and disposal tray and a disposable liner of the present invention;

FIG. 13A is a top perspective view of a drain line cap of the present invention; and

FIG. 13B is a bottom perspective view of a drain line cap of the present invention.

### DESCRIPTION OF THE PREFERRED EMBODIMENTS

For purposes of describing the preferred embodiment, the terminology used in reference to the numbered accessories in the drawings is as follows:

1. toilet removal and disposal tray, generally

2. toilet

3. planar base panel

4. top surface of planar base panel

5. bottom surface of planar base panel

6. perimeter edge of planar base panel

7. perimeter wall

8. upper edge of perimeter wall

9. lip

10. elongated handle

11. slot

12. drain line connector

13. bolt hole connector

14. drain line

15. bolt hole

16. finger spring

17. wheel

18. absorbent liner

19. strap

20. attachment means

21. fastening means

22. liner

23. drain line cap

24. upper panel

25. perimeter wall

26. perimeter edge

27. aperture in drain line cap

28. lower edge of perimeter wall

29. bottom surface of upper panel

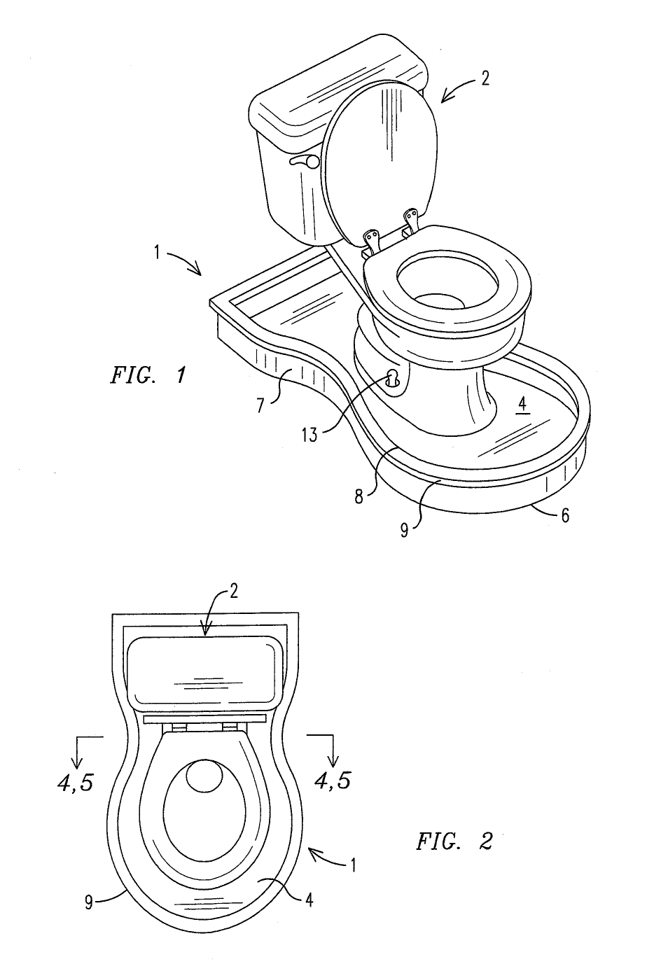

With reference to FIGS. 1 and 2, a perspective side view and a top view, respectively of a toilet removal and disposal tray 1 having a toilet 2 located therein are illustrated. The toilet removal and disposal tray 1 comprises a planar base panel 3 having a top surface 4, a bottom surface 5, and a perimeter edge 6. A perimeter wall 7 extends upward a predetermined distance from the perimeter edge 6. An upper edge 8 of the perimeter wall 7 may have a lip 9 on one or both sides to provide a place for a user to grab the toilet removal and disposal tray 1 when moving the toilet 2.

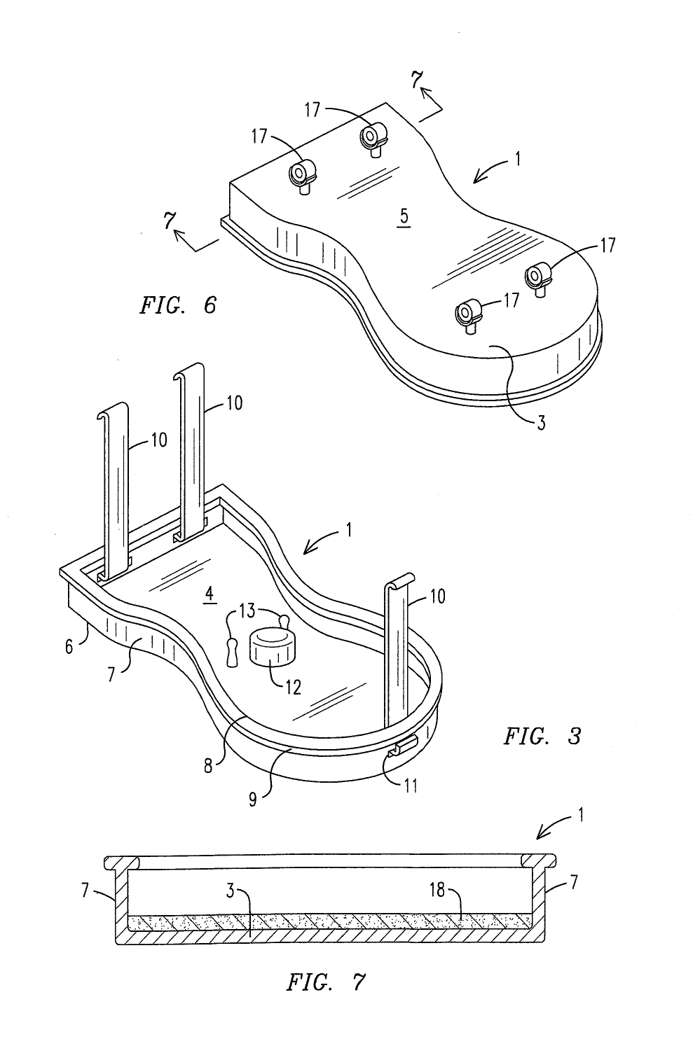

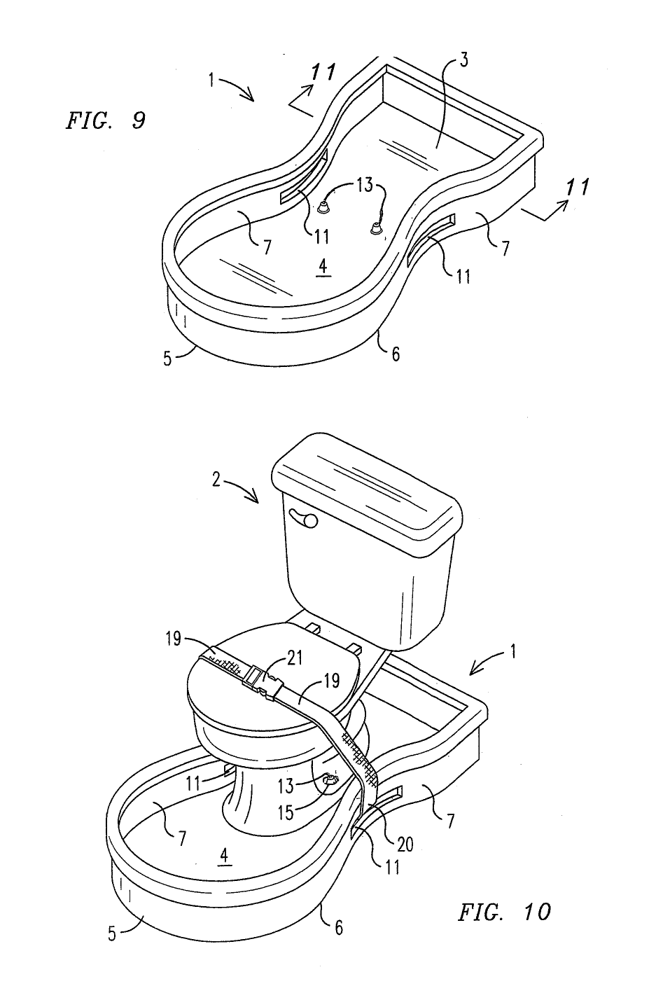

With reference to FIG. 3, a perspective side view of a toilet removal and disposal tray 1 having elongated handles 10 attached thereto is illustrated. The elongated handles 10 are preferably removably attachable to the toilet removal and disposal tray 1, and may be attached via a C-shaped distal end that hooks around the lip 9 on one or both sides of the perimeter wall 7 or through slots 11 located on the perimeter wall 7. Said slots 11 may also provide a user with areas to place his fingers through to pick up the toilet removal and disposal tray 1. Said slots may also be located on 11 either side of a toilet 2 when placed in the toilet removal and disposal tray 1 to provide attachment points for one or more straps, which may be used to secure the toilet removal and disposal tray 1 to the toilet 2, as illustrated in FIGS. 9 and 10.

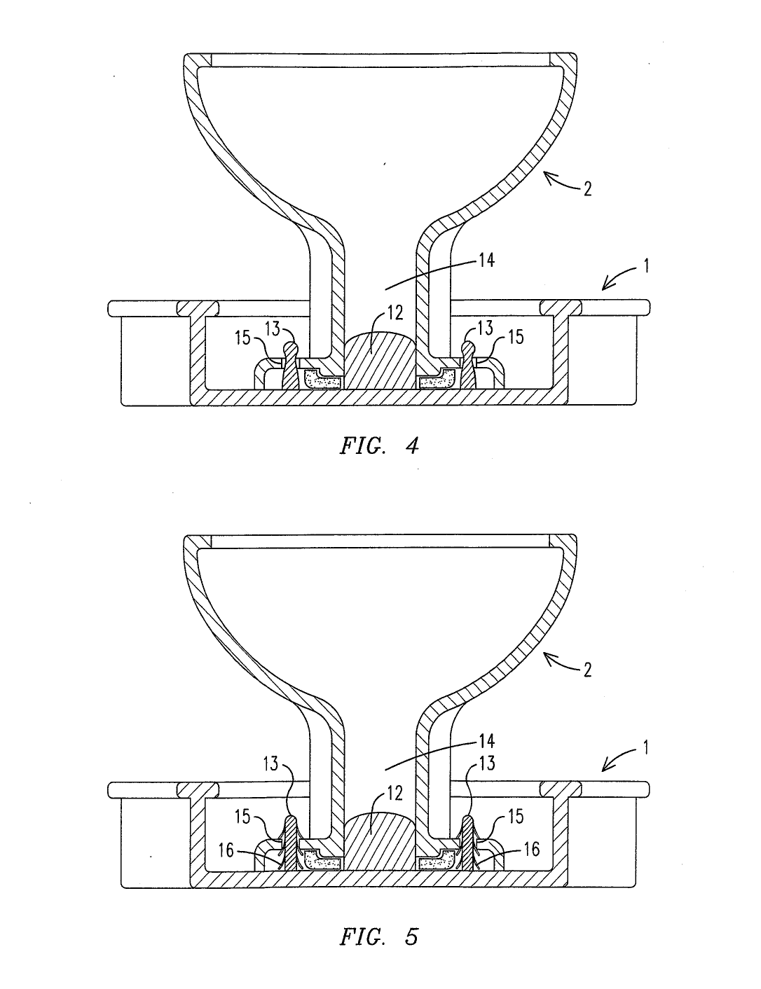

With reference to FIG. 4, a cross sectional view along the line 2-2 of FIG. 2 is illustrated showing a toilet removal and disposal tray 1 having a drain line connector 12 and bolt hole connectors 13 secured to the toilet 2 by a pressure fit. The toilet 2 is secured to the toilet removal and disposal tray 1 by a drain line connector 12, which is preferably a rounded cylindrical projection, which is centrally located on the toilet removal and disposal tray 1 and fits into the drain line 14 of the toilet 2. Two bolt hole connectors 13 (also illustrated in FIGS. 1 and 3), which are preferably finger-shaped projections, are located on either side of the drain line connector 12 and further secures the toilet to the toilet removal and disposal tray 1 by fitting through bolt holes 15 located on the base of the toilet 2. As illustrated here, the drain line connector 12 and bolt hole connectors 13 are constructed of a resilient material that provides outward pressure against the drain line 14 and the bolt holes 15 when squeezed inward, thereby creating a pressure fit.

With reference to FIG. 5, a cross sectional view along the line 2-2 of FIG. 2 is illustrated showing a toilet removal and disposal tray 1 having a drain line connector 12 and bolt hole connectors 13 secured to the toilet 2 by finger springs. The toilet 2 is secured to the toilet removal and disposal tray 1 by a drain line connector 12, which is preferably a rounded cylindrical projection, which is centrally located on the toilet removal and disposal tray 1 and fits into the drain line 14 of the toilet 2. Two bolt hole connectors 13, which are preferably finger-shaped projections, are located on either side of the drain line connector 12 and further secures the toilet to the toilet removal and disposal tray 1 by fitting through bolt holes 15 located on the base of the toilet 2. As illustrated here, the drain line connector 12 and bolt hole connectors 13 have finger springs 16 that automatically expand outward to lock the bolt hole connectors 13 and drain line connector 12 to the toilet.

With reference to FIG. 6, a perspective bottom view of a toilet removal and disposal tray 1 of the present invention having wheels 17 located thereon. The toilet removal and disposal tray 1 may comprise wheels 17 may attached directly to the toilet removal and disposal tray 1 on the bottom surface 5 of the planar base panel 3 (as illustrated here). Alternatively, a dolly or second planar panel having wheels 17 attached thereto that is removably attachable to the toilet removal and disposal tray 1.

With reference to FIG. 7, a cross sectional view along the line 6-6 of FIG. 6 is illustrated. The toilet removal and disposal tray 1 may comprise an absorbent liner 18 adjacent to the perimeter wall and/or planar base panel 3 to soak up any water that drains from the toilet 2 into the toilet removal and disposal tray 1, thereby further preventing water from leaking onto the floor.

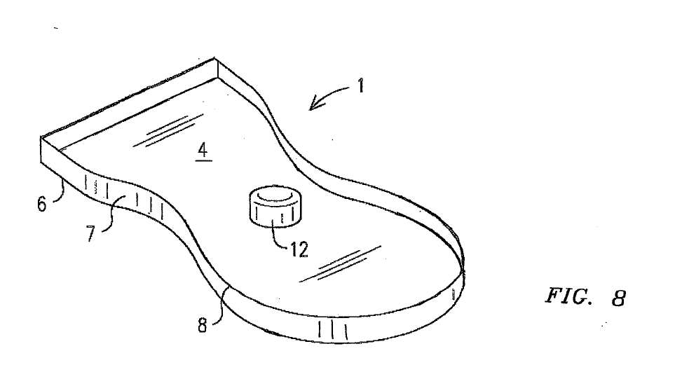

With reference to FIG. 8, a perspective side view of a simplified toilet removal and disposal tray 1 of the present invention is illustrated. The toilet removal and disposal tray 1 comprises a planar base panel 3 having a top surface 4, a bottom surface 5, and a perimeter edge 6. A perimeter wall 7 extends upward a predetermined distance from the perimeter edge 6. The toilet 2 is secured to the toilet removal and disposal tray 1 by a drain line connector 12, which is preferably a rounded cylindrical projection, which is centrally located on the toilet removal and disposal tray 1 and fits into the drain line 14 of the toilet 2, as illustrated in FIGS. 4 and 5. The drain line connector 12 may also be angled, having a diameter that increases from top to bottom like a conical shape, to allow for easier insertion into the drain line 14 of the toilet 2.

With reference to FIG. 9, a perspective side view of a toilet removal and disposal tray 1 having strap slots 11 located thereon is illustrated. The toilet removal and disposal tray 1 comprises a planar base panel 3 having a top surface 4, a bottom surface 5, and a perimeter edge 6. A perimeter wall 7 extends upward a predetermined distance from the perimeter edge 6.

Two bolt hole connectors 13, which are preferably finger-shaped projections, are located on the planar base panel 3 and extend upward a predetermined distance from the top surface 4. The bolt hole connectors 13 are preferably conically-shaped to allow the bolt hole connectors 13 to fit through bolt holes 15 located on the base of the toilet 2, as illustrated in FIG. 10.

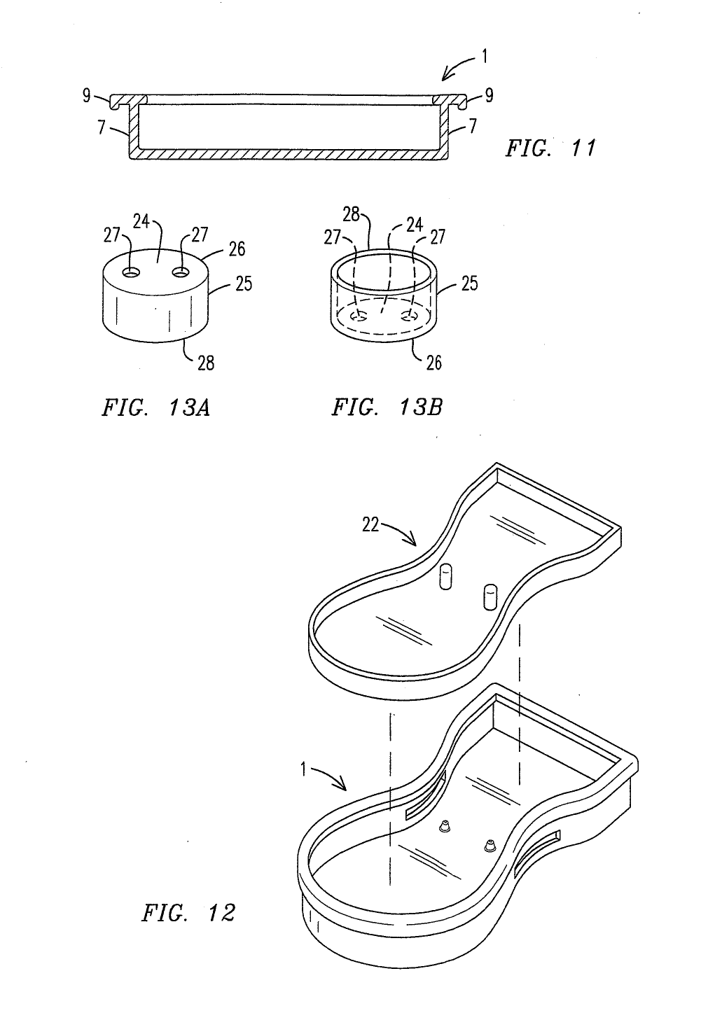

An upper edge 8 of the perimeter wall 7 may have a lip 9 on one or both sides to provide a place for a user to grab the toilet removal and disposal tray 1 when moving the toilet 2. The upper edge 8 of the perimeter wall 7 may have a curved lip 9 on one or both sides to provide a place for a user to grab the toilet removal and disposal tray 1 when moving the toilet 2, as illustrated in FIG. 11.

Slots 11 are located on the perimeter wall 7 on opposing sides of a toilet 2 when placed in the toilet removal and disposal tray 1 to provide attachment points for one or more straps 19, as illustrated in FIG. 9. Said slots 11 also provide a user with areas to place his or her fingers through to pick up the toilet removal and disposal tray 1.

With reference to FIG. 10, a perspective side view of a toilet removal and disposal tray 1 having a toilet 2 located therein secured by straps 19 is illustrated. Slots 11 are located on the perimeter walls 7 on opposing sides of a toilet 2 when placed in the toilet removal and disposal tray 1 to provide attachment points for one or more straps 19. The straps 19 attach to the slots 11 by one or more attachment means 20, such as hook and loop fastener, hooks, sewing, buckles, clip and so forth. The straps 19 may be a single strap 19 that is elastomeric and stretches over the toilet 2, a single strap 19 the is capable of being cinched down and tightened over the toilet 2, or two or more straps that are fastened together via a fastening means 21, such as a buck, clip, hooks, teeth and pawls (such as cable ties) and so forth. Bolt hole connectors 13 fit through bolt holes 15 located on the base of the toilet 2

With reference to FIG. 11, a cross sectional view along the line 11-11 of FIG. 9 is illustrated. An upper edge 8 of the perimeter wall 7 may have a lip 9 on one or both sides to provide a place for a user to grab the toilet removal and disposal tray 1 when moving the toilet 2. The upper edge 8 of the perimeter wall 7 may have a curved lip 9 on one or both sides to provide a place for a user to grab the toilet removal and disposal tray 1 when moving the toilet 2.

With reference to FIG. 12, an exploded perspective side view of a toilet removal and disposal tray 1 and a disposable liner 22 of the present invention is illustrated. The toilet removal and disposal tray 1 may be used in conjunction with a liner 22 having substantially the same shape as the toilet removal and disposal tray 1. The liner 22 will catch and debris from a wax ring and/or water and may be disposed of with the toilet 2, thereby leaving the toilet removal and disposal tray 1 to be re-used. The liner 22 is especially ideal for a more rigid reusable version of the toilet removal and disposal tray 1 of the present invention.

With reference to FIGS. 13A and 13B, a drain line cap 23 of the present invention is illustrated. The drain line cap 23 may be used after a toilet is removed from the sewer drain to prevent gas and odor from escaping from the sewer drain and into a bathroom. The drain line cap 23 has a preferably circular-shaped upper panel 24 and a perimeter wall 25 extending downward from a perimeter edge 26 of the upper panel 24 that fits over a toilet drain flange. As illustrated here, the drain line cap 23 may be secured to a conventional toilet drain flange using nuts and bolts similar to the method used to secure a toilet to a toilet drain flange by placing the bolts though apertures 27 located in the upper panel 24. In addition, a gasket may be located along a lower edge 28 of the perimeter wall and/or on an inner surface of the perimeter wall 25 to create a seal between the drain line cap 23 and a toilet drain flange. The drain line cap 23 may also be secured using a friction fit created by the gasket and/or the perimeter wall 24 and the toilet drain flange. The drain line cap may also have posts extending downward from a bottom surface 29 of the upper panel 24 that terminate with circular heads (similar to bolt heads) that will engage apertures and slots in the toilet drain flange, thereby allowing the drain line cap 23 to be locked onto the toilet drain flange. An advantage of the drain line cap 23 is that it may be removably attached to the toilet removal and disposal tray 1 via an attachment means, such as bolts, adhesive, tape and so forth, so that it will be readily available for use when an old toilet is removed.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not to be considered limited to what is shown and described in the specification and drawings.

Having thus described my invention, I claim:

1. A toilet removal and disposal tray comprising:
a planar base panel having a top surface, a bottom surface and a perimeter edge;
a perimeter wall extending upward a predetermined distance from the perimeter edge;
an upper edge located on the perimeter wall; and
at least one bolt hole connector located on the planar base panel and extending upward a predetermined distance from the top surface of the planar base panel.

2. The toilet removal and disposal tray of claim 1 wherein:
said at least one bolt hole connector is conically-shaped.

3. The toilet removal and disposal tray of claim 2 wherein:
said at least one bolt hole connector is made of a resilient material to create a pressure fit when the toilet when the toilet removal and disposal tray is attached to the toilet.

4. The toilet removal and disposal tray of claim 1 further comprising:
a lip located on the upper edge of the perimeter wall.

5. The toilet removal and disposal tray of claim 4 wherein:
said lip is a curved lip.

6. The toilet removal and disposal tray of claim 1 further comprising:
at least one slot located on the perimeter wall.

7. The toilet removal and disposal tray of claim 1 further comprising:
at least one wheel located on the toilet removal and disposal tray to assist a user in transporting the toilet removal and disposal tray.

8. The toilet removal and disposal tray of claim 1 further comprising:
at least one strap attached to the side wall used for securing a toilet to the toilet removal and disposal tray.

9. The toilet removal and disposal tray of claim 1 further comprising:
a disposable liner that rests on the top surface of the planar base panel.

10. The toilet removal and disposal tray of claim 1 further comprising:
a drain line connector located on the planar base panel for attaching the toilet removal and disposal tray to a toilet.

11. The toilet removal and disposal tray of claim 1 further comprising:
a drain line cap attached to the toilet removal and disposal tray via and attachment means;
said drain line cap having a circular-shaped upper panel and a perimeter wall extending downward from a perimeter edge of the upper panel a predetermined distance; and
at least two apertures located on the upper panel.

12. A toilet removal and disposal tray comprising:
a planar base panel having a top surface, a bottom surface and a perimeter edge;
a perimeter wall extending upward a predetermined distance from the perimeter edge;
an upper edge located on the perimeter wall; and
a drain line connector located on the planar base panel for attaching the toilet removal and disposal tray to a toilet.

13. The toilet removal and disposal tray of claim 12 wherein:
said drain line connector is made of a resilient material to create a pressure fit when the toilet when the toilet removal and disposal tray is attached to the toilet.

14. The toilet removal and disposal tray of claim 12 further comprising:
a lip located on the upper edge of the perimeter wall.

15. The toilet removal and disposal tray of claim 14 wherein:
said lip is a curved lip.

16. The toilet removal and disposal tray of claim 12 further comprising:
at least one slot located on the perimeter wall.

17. The toilet removal and disposal tray of claim 12 further comprising:
at least one wheel located on the toilet removal and disposal tray to assist a user in transporting the toilet removal and disposal tray.

18. The toilet removal and disposal tray of claim 12 further comprising:
at least one strap attached to the side wall used for securing a toilet to the toilet removal and disposal tray.

19. The toilet removal and disposal tray of claim 12 further comprising:
a disposable liner that rests on the top surface of the planar base panel.

20. The toilet removal and disposal tray of claim 12 further comprising:
at least one bolt hole connector located on the planar base panel and extending upward a predetermined distance from the top surface of the planar base panel.

21. The toilet removal and disposal tray of claim 12 further comprising:
a drain line cap attached to the toilet removal and disposal tray via and attachment means;
said drain line cap having a circular-shaped upper panel and a perimeter wall extending downward from a perimeter edge of the upper panel a predetermined distance; and
at least two apertures located on the upper panel.

22. A toilet removal and disposal tray comprising:
a planar base panel having a top surface, a bottom surface and a perimeter edge;
a perimeter wall extending upward a predetermined distance from the perimeter edge;
an upper edge located on the perimeter wall; and
at least one strap attached to the side wall used for securing a toilet to the toilet removal and disposal tray.

23. The toilet removal and disposal tray of claim 22 further comprising:
a drain line cap attached to the toilet removal and disposal tray via and attachment means;
said drain line cap having a circular-shaped upper panel and a perimeter wall extending downward from a perimeter edge of the upper panel a predetermined distance; and
at least two apertures located on the upper panel.

24. A drain line cap comprising:
a circular-shaped upper panel and a perimeter wall extending downward from a perimeter edge of the upper panel a predetermined distance; and
at least two apertures located on the upper panel.
